(19) United States
(12) Patent Application Publication
(10) Pub. No.: US 2020/0377387 A1
(43) Pub. Date: Dec. 3, 2020

(54) Electrode Assembly, System and Method for Inactivating Organic Material in a Flow of Water

(71) Applicant: National Oilwell Varco Norway AS, Kristiansand S (NO)

(72) Inventors: Yury VARANKO, Hafrsfjord (NO); Eirik DIRDAL, Randaberg (NO)

(73) Assignee: National Oilwell Varco Norway AS, Kristiansand S (NO)

(21) Appl. No.: 16/604,938

(22) PCT Filed: Apr. 11, 2018
(86) PCT No.: PCT/NO2018/050100

§ 371 Date: Oct. 11, 2019

(30) Foreign Application Priority Data
Apr. 28, 2017 (EP) 17168711.4

(51) Int. Cl. C02F 1/467; C02F 1/461

(52) U.S. Cl. CPC C02F 1/4672; C02F 1/46109; C02F 2201/4616; C02F 2303/04; C02F 2001/46157; C02F 2305/023

(57) ABSTRACT

Disclosed is an electrode assembly and a method for inactivating organic material in water, and a water treatment system that includes the electrode assembly. The electrode assembly includes a longitudinal axis and at least an anode and a cathode, each having a first electrode member that includes a perforated portion for water to pass through and a second electrode member arranged at an angle with respect to the first electrode member, and also having a perforated portion for water to pass through. The first and second electrode members of the anode correspond to and are arranged in close proximity to the first and second electrode members of the cathode. The first and second electrode members are inclined with respect to the assembly's axis.

### CROSS REFERENCE TO RELATED APPLICATIONS

This application is a 35 U.S.C. § 371 national stage application of PCT/NO2018/050100 filed Apr. 11, 2018 and entitled “Electrode Assembly, System and Method for Inactivating Organic Material in a Flow of Water”, which claims priority to European Patent Application No. 17168711.4 filed Apr. 28, 2017, each of which is incorporated herein by reference in their entirety for all purposes.

### STATEMENT REGARDING FEDERALLY SPONSORED RESEARCH OR DEVELOPMENT

Not Applicable.

### FIELD OF THE DISCLOSURE

This disclosure relates to an electrolytic device for the production of short-lived free radicals, such as hydroxyl (OH—) radicals, chlorine dioxide, dissolved ozone, and hydrogen peroxide, with the aim of inactivating organic material from water in a water flow, before injection into a well. The disclosure also relates to a system for water treatment, wherein the system comprises said electrolytic device. Furthermore, the disclosure relates to a method for arranging said electrolytic device in a flow path.

By “inactivating organic material” is herein particularly meant to kill off microorganisms such as plankton, bacteria, protozoa and viruses present in a flow of water.

### BACKGROUND

Electrochemical production of oxidants, such as free hydroxyl radicals, is well known and widely used in the water treatment industry with the purpose of inactivating organic material and thus disinfecting the water. It is known to use electrode meshes which are arranged perpendicularly to the water flow. It is a challenge that higher order oxidants are extremely reactive and will undergo a chemical reaction within nanoseconds after they are formed. It is therefore only the water which is close to the electrodes which will be treated by the free hydroxyl radicals.

Patent publication U.S. Pat. No. 8,080,150 B2 shows an example of an electrolytic cell wherein the electrodes are arranged substantially perpendicularly to the water flow. The electrodes are arranged in pairs, one cathode and one anode, wherein the electrodes within each pair are arranged at a relatively small distance from each other. Disadvantages of arranging the electrodes perpendicularly to the water flow are that the water's residence time between the electrodes is short, and that the contact area between the water and the electrodes is limited. These disadvantages result in a treatment process which is not very efficient.

The disclosure is directed toward remedying or at least reducing one or more of the drawbacks of the prior art or at least to provide a useful alternative to prior art.

### SUMMARY OF THE DISCLOSURE

In a first aspect, the disclosure relates more particularly to an electrode assembly for inactivating organic material in water, the electrode assembly having a longitudinal axis, and comprising:
at least one electrode unit comprising at least two electrodes whereof at least one anode and one cathode, wherein the electrodes comprise:
a first electrode member comprising a perforated portion for water to pass through; and
a second electrode member arranged at an angle with respect to the first electrode member, and comprising a perforated portion for water to pass through;
wherein the first and second electrode members of the anode correspond to and are arranged in close proximity to the first and second electrode members of the cathode.

The electrode assembly is an electrolytic device which, when connected to a power supply, is able to produce free radicals, such as for instance hydroxyl (OH—) radicals. For treatment of water which is contaminated by organic material, the electrode assembly may be placed in a water flow, preferably in a confined space having an inlet opening and an outlet opening. The electrode assembly may preferably be oriented in such a way that the flow direction of the water flow upon entering the confined space though the inlet opening is substantially aligned with the longitudinal axis of the electrode assembly. The features that each electrode comprises a first electrode member and a second electrode member which are arranged at an angle with respect to the first electrode member, and which extend in the longitudinal direction of the electrode assembly provide a larger contact surface for the water to be treated. This solves the problem of the short contact time for electrodes arranged perpendicularly to the water flow.

In order to solve the problem of the short contact time/small contact surface, it is known from prior art to arrange solid, plate-shaped electrodes parallel to the water flow. An example of this is shown in U.S. Pat. No. 5,419,824. This solution provides longer residence time between the electrodes for the water to be treated, and the contact area is larger since the water flows along the electrodes. One challenge for this kind of arrangement is that there may be a considerable pressure drop in the water flow. Such pressure drop may lead to scale building up on the electrodes of the device due to precipitation, and thereby creating a significant restriction, or even a plug. The amount of precipitation is also affected by change in temperature, but as the temperature is quite stable through the relatively short device, pressure change constitutes the main contributor to precipitation.

A solution disclosed herein reduces the pressure drop due to the perforated portions of the electrodes. In this manner the electrode assembly gets a large effective electrode area at the same time as it allows for high flow rate. High flow rate is an advantage when large volumes of water are to be treated.

The first and second electrode members may extend in the longitudinal direction of the longitudinal axis of the electrode assembly. By the term “extend in the longitudinal direction” as used herein, is meant that the extension of the electrode members is larger in the longitudinal direction of the electrode assembly, than in any other direction.

Each of the electrodes may comprise at least one further electrode member comprising a perforated portion. This is a possible embodiment of the electrode assembly.

The electrode members may be inclined with respect to the longitudinal axis of the electrode assembly. If the electrode members are inclined with respect to the longitudinal axis of the electrode assembly, the water will hit the electrode members at different angles.

The electrode assembly is arranged to be placed in a flow of water, such that the water passes from a first end of the longitudinal axis of the electrode assembly and to a second end of the longitudinal axis of the electrode assembly. On its way through the electrode assembly, the water flow will obviously be disturbed by the electrode assembly and the flow direction of the water will therefore not be uniform. When water passes through the perforated portions of the electrode members it will get in contact with radicals produced between the anode and the cathode, and any organic material in the water will be inactivated. When the electrode members are tilted with regards to the longitudinal axis of the electrode assembly, it is possible to obtain a large contact area between the water and the electrode members at the same time as the pressure drop is reduced even further.

The electrode members of the anode and the electrode members of the cathode may be arranged substantially equidistant with regards to each other. This may for example be done by providing a spacer between the electrode members of the anode and the electrode members of the cathode, to ensure that the distance is at least substantially equal everywhere. The effect of having the same distance between the electrode members throughout the entire extension of the electrode members is that the treatment of the water will be more uniform and more predictable than if the distance varies. In an alternative embodiment, the spacer may be made with a varying thickness, so as to have a slightly changing distance between the electrodes over the electrode area.

In some embodiments, the electrode members may be arranged around the longitudinal axis of the electrode assembly. If the electrode members are inclined with regards to the longitudinal axis, this means that the electrode members at a first end are close to the longitudinal axis and at a second end are further away from the longitudinal axis. Therefore, it is advantageous if the electrode members, and in particular the perforated portion of the electrode members, are wider at the second end than they are at the first end. It would be even more advantageous if the width of the electrode members gradually increase from the first end to the second end. The electrode members may have the shape of trapeziums, or in particular isosceles trapeziums, but are not limited thereto. The electrode members may alternatively be for instance rectangles. The shape of the electrode members, and their optional growing contact surface from the first end to the second end, will influence on the efficiency of the water treatment. The larger the contact surface, the more efficient treatment. The electrode assembly may be placed in the water flow either such that water enters the more narrow part of the electrode assembly, i.e. where the electrode members are closest to the longitudinal axis, or such that water enters the wider part of the electrode assembly, i.e. where the electrode members are further away from the longitudinal axis of the electrode assembly.

The electrode members may be plate-shaped, but other shapes are possible. Plate-shaped electrode members, in particular plate-shaped perforated portions of electrode members, are easy to produce and may easily be adapted to different geometrical shapes. However, the electrode members may alternatively be curved.

The electrode unit may comprise a further electrode. It would be a possible embodiment to provide three electrodes in a sandwich structure, i.e. an anode between two cathodes, since the free radicals are produced on the cathode, and two cathodes thus would provide more free radicals and consequently a more efficient treatment of the water passing through.

The electrode members of each electrode may be arranged such that they constitute a funnel-shaped electrode portion. It is an advantage if the electrode members are connected to each other such as to form a continuous structure through which water can flow. Such a continuous structure would be easier to install in a water flow, and it would provide better predictability of the treatment of the water, since all the water which is directed through the electrode assembly will be in contact with the electrode members.

In some embodiments, the electrode assembly may be arranged such in a water flow that all of the water has to pass through at least one of the perforated portions of the electrode members.

The electrode members of each electrode may alternatively be arranged such that they constitute the side walls of a prism. The prism may be an oblique prism, i.e. having side walls inclined with regards to the longitudinal axis of the electrode assembly.

The funnel-shaped electrode portion or the prism may have a polygonal base structure, such as trigonal, tetragonal, pentagonal, or hexagonal. Other shapes are also possible. However, if the electrode members are curved, also a circular or even oval shaped base structure is possible. The base structure is not necessarily limited to a regular shape, also an irregular shape is possible.

The electrode assembly may comprise a plurality of electrode units. Each electrode unit comprises at least two electrodes, one anode and one cathode, as described above. It is possible to provide a plurality of such electrode units in the electrode assembly, either along the same longitudinal axis, i.e. one after the other, or along different longitudinal axes.

The electrode units may be stackable on each other.

The electrode assembly may further comprise a tubular housing for enclosing the electrode unit(s) and for defining a flow path for the water to be treated.

The/each electrode unit may further comprise a base portion for connecting the electrodes to a power source. The base portion will be provided with an opening for letting the water flow through the base portion such as to get in contact with the electrodes. In the event that two or more electrode units are arranged along different longitudinal axes, in some embodiments, they will share the same base portion. The base portion may further be arranged to guide all of the water through the perforated portions of the electrodes.

The base portion may be shaped such that the circumference of the base portion substantially corresponds to the outer circumference of the tubular housing. This is one of the preferred embodiments because the base portion, with its opening, will guide the entire flow of water which is to be treated, through to the perforated portions of the electrode members, such that it will get in contact with the free radicals and any organic material will be inactivated.

The tubular housing may comprise of two parts which are connectable to each other, or to an intermediate element connectable to both parts. The base portion may then be such an intermediate element. The base portion may be arranged between the two parts of the tubular housing and connected thereto, such that the tubular housing, the base portion and the electrode members connected to the base portion, form one electrode assembly.

The perforated portions of the electrode members may comprise a mesh, either a fine mesh or a coarse mesh.

The electrode members may be provided with power distribution means. It may be desireable to distribute the power along the electrode members in order to provide a more even distribution compared to what is known in the art. Prior art power connection to an electrode is via one point. The idea with a power distribution means is to spread the power to at least two but possibly a plurality of connection points.

The power distribution means may be a slot provided on each electrode member for providing a short-cut for electricity from a point for connecting the electrode member to a power source and to at least two different locations on the perforated portion of the electrode member.

A second aspect of the disclosure relates more particularly to a power distribution means for the electrode assembly that has been described above with reference to the first aspect, comprising a frame for being arranged around a perforated portion of an electrode member, wherein said frame is provided with a slot for providing a short-cut for electricity from a point for connecting the electrode member to a power source and to at least two different locations on the perforated portion of the electrode member.

A third aspect of the disclosure relates more particularly to a treatment system for water contaminated with organic material, wherein the treatment system comprises the electrode assembly as described above according to the first aspect. Such a treatment system may for instance be for treating injection water before injecting it into a wellbore.

The treatment system may further comprise the power distribution means according to the second aspect described above.

In a fourth aspect, the disclosure relates more particularly to a method for inactivating organic material in water, wherein the method comprises the following steps:
providing a confined space having a longitudinal axis, an inlet opening and an outlet opening;
arranging an electrode assembly according to the first aspect in the confined space, such that the longitudinal axis of the electrode assembly is aligned with the longitudinal axis of the confined space; and
letting the water in through the inlet opening, through the electrode assembly in the confined space, and out through the outlet opening.

### BRIEF DESCRIPTION OF THE DRAWINGS

In the following are described examples of preferred embodiments illustrated in the accompanying drawings, wherein:

FIG. 1 shows an electrode assembly according to this disclosure;

FIG. 2 shows another electrode assembly according to this disclosure;

FIGS. 3a-3f shows examples of other possible embodiments of the electrode assembly of the disclosure;

FIG. 4 shows an electrode member of an anode and of a cathode that may have application as part of the electrode assemblies described in this disclosure;

FIG. 5 shows an exploded view of an electrode assembly of FIG. 1;

FIG. 6 is a cross sectional view of an electrode assembly according to this disclosure and that includes a power supply;

FIG. 7 is a cross sectional view of another electrode assembly according to this disclosure that includes a power supply; and

FIG. 8a-b shows a system for water treatment employing an electrode assembly made in accordance with this disclosure

### DETAILED DESCRIPTION OF THE DISCLOSED EXEMPLARY EMBODIMENTS

The figures are shown in a simplified and schematic manner, and details that are not important in order to disclose and explain the structure and operation of the disclosed embodiments may have been omitted from the figures. The various elements in the figures are not necessarily shown to scale relative to each other. Like or corresponding elements will be indicated by the same reference numeral in the figures.

Any positional specifications such as “over”, “under”, “above”, “below”, “left” and “right” reflect the position shown in the figures.

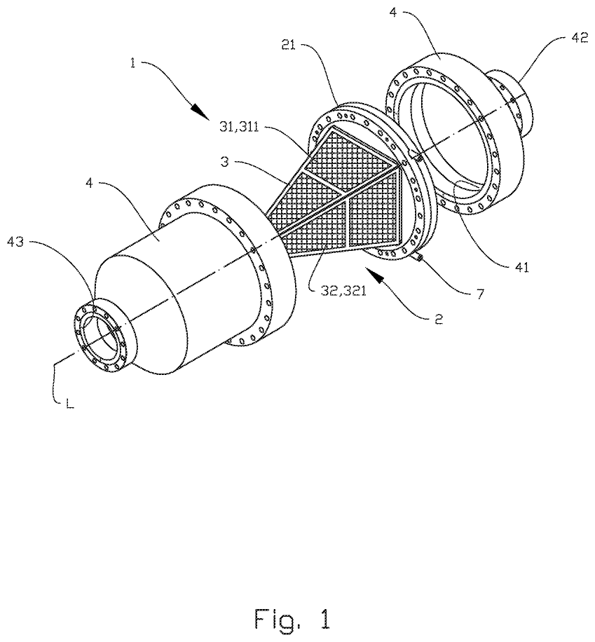

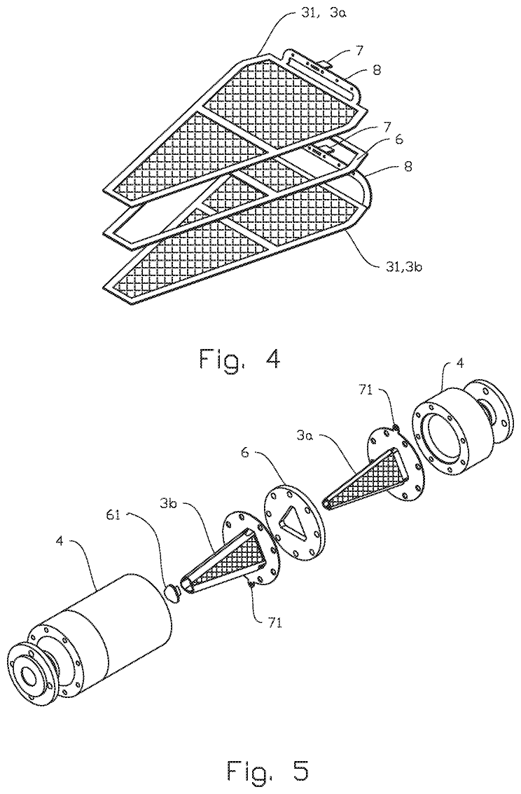

Reference is first made to FIG. 1 which shows an electrode assembly 1 having a longitudinal axis L. The electrode assembly 1 is here shown before it is completely assembled. A tubular housing 4 is shown as two parts not yet assembled. An electrode unit 2 is arranged between the two parts of the tubular housing 4. The electrode unit 2 comprises a base portion 21 which is here shown in a shape and size adapted to be sandwiched between, and connected to, the two parts of the tubular housing 4. The electrode unit 2 further comprises electrodes 3, whereof in FIG. 1 only one is visible, as two electrodes 3, an anode 3a and a cathode 3b (see FIGS. 4 and 5) are arranged one covering the other. The electrodes 3 consist of at least two electrode members 31, 32 each. In FIG. 1, only two electrode members 31, 32 are visible, each comprising perforated portions 311, 321 for water to pass through. The electrode members 31, 32 are connected to the base portion 21. A not shown power source may be connected to the base portion 21 in order to provide the electrodes 3 with electricity such that free radicals may be formed.

The tubular housing 4 encloses a confined space 41, and it is provided with an inlet opening 42 and an outlet opening 43. The electrode assembly 1 may be oriented the opposite way in a flow of water, meaning that the inlet opening 42 could instead be the outlet opening, and the outlet opening 43 could instead be the inlet opening.

The electrode members 31, 32 are inclined with regards to the longitudinal axis L, and here they are shown connected to each other.

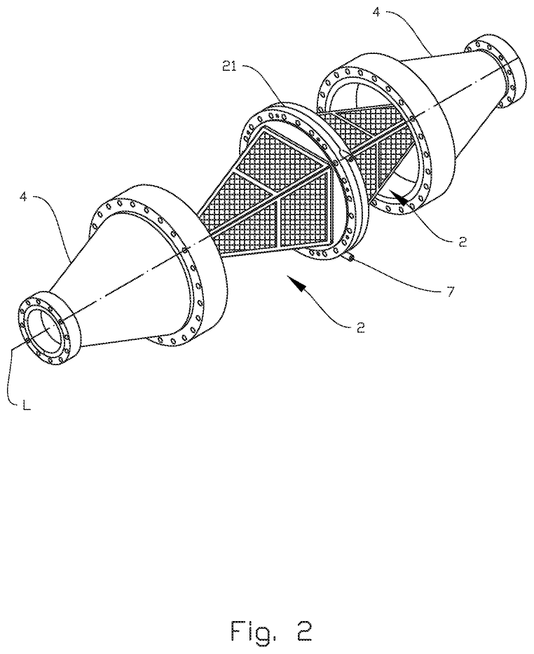

In FIG. 2 two electrode units 2 are shown. The electrode units 2 are arranged opposite of each other, sharing the same base portion 21. The shape of the tubular housing 4 is altered from that shown in FIG. 1 so as to house both electrode units 2. It must be understood that the shown geometrical shapes of both the housing 4 and of the electrode units 2 are only exemplary. Many different shapes are possible. Also electrode units 2 may be stacked upon each other instead of, or in addition to, electrode units 2 sharing base portion 21. One electrode assembly 1 may have a plurality of electrode units 2.

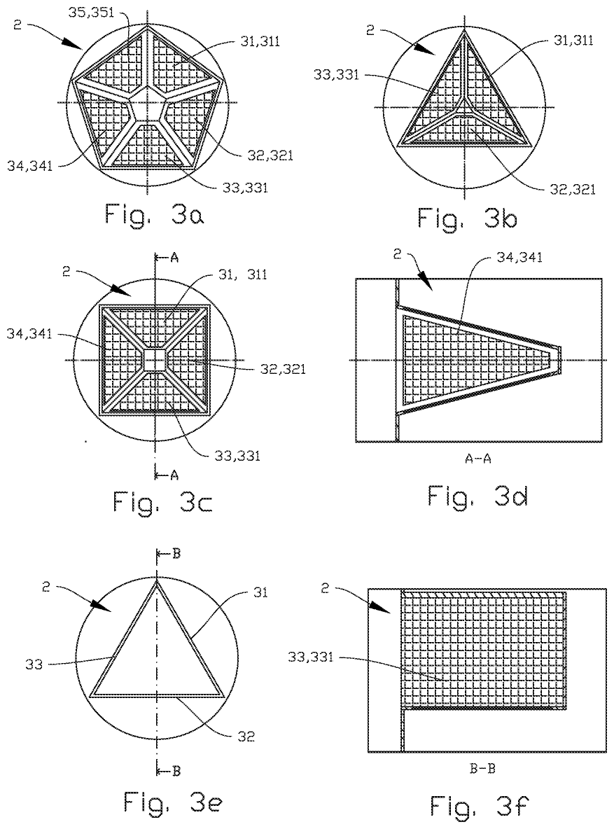

In FIGS. 3a, 3b, 3c and 3e are shown different possible base structures of the electrode units 2. FIG. 3a shows an electrode unit 2 with a pentagonal base structure. The electrode unit 2 is seen from above. This embodiment of the electrode unit 2 is constituted by five electrode members 31, 32, 33, 34, 35, each having a perforated portion 311, 321, 331, 341, 351. Similarly FIG. 3b shows an electrode unit 2 having a trigonal base structure, thus having three electrode members 31, 32, 33 each having a perforated portion 311, 321, 331. In FIG. 3c the base structure is tetragonal, with electrode members 31, 32, 33, 34 and corresponding perforated portions 311, 321, 331, 341. FIG. 3d shows the cross section through the line A-A in FIG. 3c, where electrode member 34 with perforated portion 341 can be seen in the figure. FIG. 3e shows a three-sided prismatic embodiment of an electrode unit, wherein the electrode members 31, 32, 33 will be non-inclined with respect to the longitudinal axis L of the electrode assembly when installed therein. FIG. 3f shows a cross-section seen through the line B-B from FIG. 3e, where the electrode member 33 and corresponding mesh 331 can be seen in the figure.

In FIG. 4, an electrode member 31 of an anode 3a and an electrode member 31 of a cathode 3b are shown in a sandwich structure with a spacer element 6 between the electrode members 31. The purpose of the spacer element 6 is to keep the two electrode members 31 equidistant to each other. Each electrode member is provided with a connecting means 7 for connecting to a power source. Said connecting means 7 is transferring power to the perforated portion 311 of the electrode member 31. In some embodiments, such as shown here, the connecting means 7 is transferring the power via a power distribution means 8. The power distribution means 8 distributes the power from the connecting means 7 to at least two locations of the edge of the perforated portion 311.

FIG. 5 shows an embodiment of the electrode assembly 1 of FIG. 1 in an exploded view. Here the anode 3a and the cathode 3b are shown as trigonal funnel-shaped structures, stackable on each other meaning that, in this embodiment, the extending, trigonal funnel-shaped portion of the anode 3a is fitted within the interior recess of the trigonal funnel-shaped portion of cathode 3b. The spacer element 6 is here shown as a circular disc with an opening provided therein for receiving the trigonal funnel-shaped portion of the anode 3a and a cap 61 keeping the narrow ends of the electrodes 3a, 3b at fixed position relative to each other and closing the narrow end of the funnels-shaped structure. The connection means 7 of both the anode 3a and the cathode 3b are here shown as ears 71 which, when the embodiment is assembled, will extend on the outside of the tubular housing 4 for easy connection to a power source.

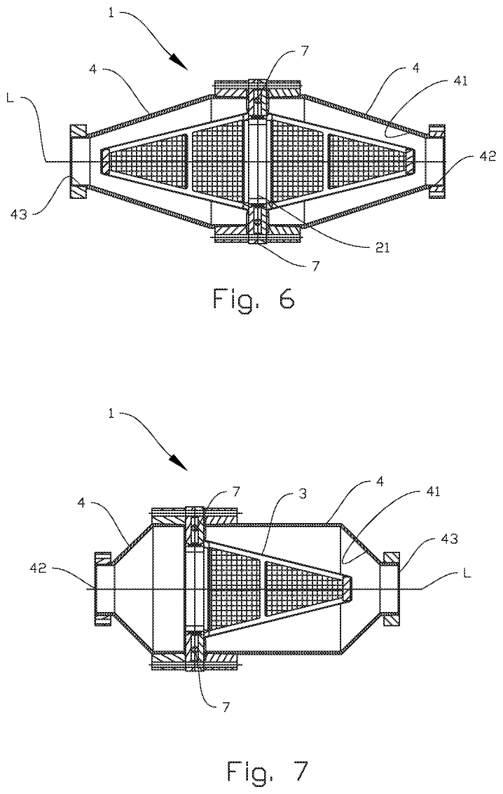

FIG. 6 shows an embodiment of the electrode assembly 1 wherein two electrode units 2 are provided. The electrode units 2 are arranged opposite of each other, i.e. they have a common base portion 21.

FIG. 7 is a cross-section through the assembled version of the electrode assembly 1 shown in FIG. 1. The electrodes 3 are provided within the confined space 41 of the tubular housing 4, and the flow direction may be either way through the confined space 41. That means that the inlet opening 42 could alternatively be the outlet opening, and the outlet opening 43 could alternatively be the inlet opening. The connection means 7 extend on the outside of the tubular housing 4.

Other embodiments, for instance an embodiment wherein two or more electrode units 2 are stacked on each other, are also contemplated. Likewise, in another embodiment, another electrode unit 2 could be stacked upon one of the electrode units 2 of FIG. 7.

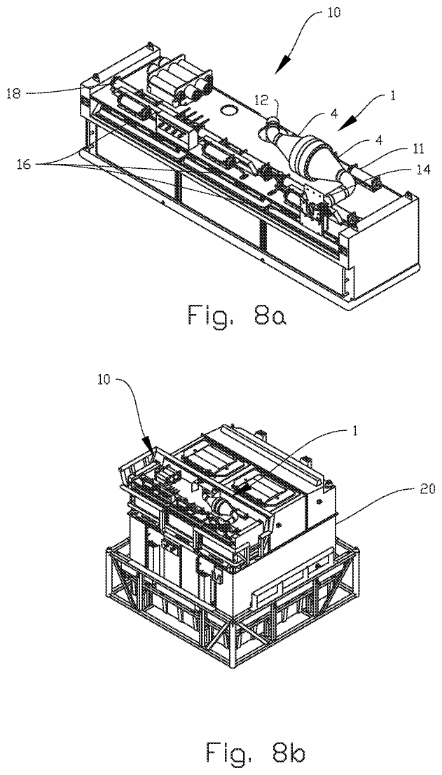

FIG. 8a shows a water treatment system 10 comprising the electrode assembly 1 described herein. The tubular housing 4 is provided between two pipelines, an inlet 12 and an outlet 14, such as to provide a continuous flow path for water to be treated by the water treatment system 10. The system 10 may comprise a plurality of different treatment units where the electrode assembly 1 for electrolytic treatment of the water constitutes one of the treatment units. The electrode assembly 1 is here shown connected to a power source 11 for providing power to the base portions 21 of the electrode units 2 of the electrode assembly 1, as indicated in FIGS. 1 and 2. Other treatment units may be typically connected to the electrode assembly 1 upstream of the inlet, while a not shown injection well may be connected to the system 10 downstream of the electrode assembly 1. In other embodiment, further treatment units may also be provided downstream of the electrode assembly. In the shown embodiment, the system 10 is further provided with a plurality of cells 16 for electro-chlorination of seawater powered by a power source 18, the cells constituting one example of such additional treatment units.

In FIG. 8b, the system 10 is shown in an exemplary position of use, where it provided together with large container 20 for gravitational precipitation of particles from seawater, where the container is provided upstream of the electrode assembly in the shown embodiment. Further details about the container 20 can e.g. be found in WO 2007/035106 A1, the entire disclosure of which is incorporated herein by this reference.

It should be noted that the above-mentioned embodiments illustrate rather than limit the invention that is claimed below, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. Electrode assembly (1) for inactivating organic material in water, the electrode assembly (1) having a longitudinal axis (L), and comprising:
at least one electrode unit (2), comprising at least two electrodes (3) whereof at least one anode (3a) and one cathode (3b), wherein the electrodes (3) comprise:
a first electrode member (31) comprising a perforated portion (311) for water to pass through; and
a second electrode member (32) arranged at an angle with respect to the first electrode member (31), and comprising a perforated portion (321) for water to pass through;
wherein the first and second electrode members (31, 32) of the anode (3a) correspond to and are arranged in close proximity to the first and second electrode members (31, 32) of the cathode (3b).

2. Electrode assembly (1) according to claim 1, wherein each of the electrodes (3) comprises at least one further electrode member (33) comprising a perforated portion (331).

3. Electrode assembly (1) according to claim 1 or 2, wherein the electrode members (31, 32, 33) are inclined with respect to the longitudinal axis (L) of the electrode assembly (1).

4. Electrode assembly (1) according to any one of the preceding claims, wherein the electrode members (31, 32, 33) of the anode (3a) and the electrode members (31, 32, 33) of the cathode (3b) are arranged substantially equidistant with regards to each other.

5. Electrode assembly (1) according to any one of the preceding claims, wherein the electrode members (31, 32, 33) are plate-shaped.

6. Electrode assembly (1) according to any one of claims 1-4, wherein the electrode members (31, 32, 33) are curved.

7. Electrode assembly (1) according to any one of the preceding claims, wherein the electrode unit (2) comprises a further electrode (3).

8. Electrode assembly (1) according to claim 2, or any one of claims 3-7 in so far as dependent on claim 2, wherein the electrode members (31, 32, 33) of each electrode (3) are arranged such that they constitute a funnel-shaped electrode portion.

9. Electrode assembly (1) according to claim 2 or any one of claims 4-7 in so far as dependent on claim 2, wherein the electrode members (31, 32, 33) of each electrode (3) are arranged such that they constitute the side walls of a prism.

10. Electrode assembly (1) according to claim 8 or 9, wherein the funnel-shaped electrode portion or the prism has a polygonal base structure, such as trigonal, tetragonal, pentagonal, or hexagonal.

11. Electrode assembly (1) according to any one of the preceding claims, comprising a plurality of electrode units (2).

12. Electrode assembly (1) according to claim 11 in so far as dependent on claim 8, wherein the electrode units (2) are stackable on each other.

13. Electrode assembly (1) according to any one of the preceding claims, further comprising a tubular housing (4) for enclosing the electrode unit(s) (2) and for defining a flow path for the water to be treated.

14. Electrode assembly (1) according to any one of the preceding claims, wherein the electrode unit (2) further comprises a base portion (21) for connecting the electrodes (3) to a power source.

15. Electrode assembly (1) according to claim 14 in so far as dependent on claim 13, wherein the base portion (21) is shaped such that the circumference of the base portion (21) substantially corresponds to the outer circumference of the tubular housing (4).

16. Electrode assembly (1) according to any one of the preceding claims, wherein the perforated portions (311, 321, 331) of the electrode members (31, 32, 33) comprise a mesh.

17. Electrode assembly (1) according to any one of the preceding claims, wherein the electrode members (31, 32, 33) are provided with power distribution means (5).

18. Electrode assembly (1) according to claim 17, wherein the power distribution means (5) is a slot provided on each electrode member (31, 32, 33) for providing a short-cut for electricity from a point for connecting the electrode member (31, 32, 33) to a power source and to at least two different locations on the perforated portion (311, 321, 331) of the electrode member (31, 32, 33).

19. Power distribution means (5) for the electrode assembly (1) according to any one of the preceding claims, comprising a frame (51) for being arranged around a perforated portion (311, 321, 331) of an electrode member (31, 32, 33), wherein said frame (51) is provided with a slot for providing a short-cut for electricity from a point for connecting the electrode member (31, 32, 33) to a power source and to at least two different locations on the perforated portion (311, 321, 331) of the electrode member (31, 32, 33).

20. Treatment system (10) for water contaminated with organic material, wherein the treatment system (10) comprises the electrode assembly (1) according to any one of claims 1-18.

21. Treatment system (10) according to claim 20, further comprising the power distribution means (5) according to claim 19.

22. Method for inactivating organic material in water, wherein the method comprises the following steps:
providing a confined space (41) having a longitudinal axis, an inlet opening (42) and an outlet opening (43);
arranging an electrode assembly (1) according to claim 1 in the confined space (41), such that the longitudinal axis (L) of the electrode assembly (1) is aligned with the longitudinal axis of the confined space (41);
connecting the electrode assembly (1) to a power source (11); and
letting the water in through the inlet opening (42), through the electrode assembly (1) in the confined space (41), and out through the outlet opening (43).
